(19) United States
(12) Patent Application Publication
(10) Pub. No.: US 2007/0226079 A1
(43) Pub. Date: Sep. 27, 2007

(54) Method and system for linking customers and vendors

(75) Inventor: Cary Chessick, Arlington Heights, IL (US)

Correspondence Address: SEYFARTH SHAW LLP, 131 S. DEARBORN ST., SUITE2400, CHICAGO, IL, 60603-5803, US

(73) Assignee: Restaurant.com, Inc.

(21) Appl. No.: 11/371,031

(22) Filed: Mar. 8, 2006

(51) Int. Cl. G06Q 30/00

(52) U.S. Cl. 705/27

(57) ABSTRACT

A method and apparatus are disclosed for facilitating and linking a vendor with a customer desiring the goods and/or services of the vendor. A remotely located system is contacted by the customer who then requests information that is displayed on a computer for the customer. The customer responds to this information by inputting data into the computer and sending the information to the remote system. This data includes information regarding, e.g., a reservation for the vendor's services. The customer also inputs a time at which they would like to be contacted for confirming the reservation. The remote system then establishes a connection with the customer at the designated time, preferably a telephonic connection allowing voice communications. Upon establishment of this connection, the remote system may play announcements and/or advertisement to the customer and, concurrently, establishes a second connection with the vendor. The second connection is also preferably a telephonic connection, and the remote system may play announcements and/or advertisements to the vendor, and connects the customer and the vendor for voice communications therebetween.

### FIELD OF THE INVENTION

The invention relates to a system and method for introducing multiple parties, in particular, for introducing a consumer of goods or services and a vendor who provides those goods and services and, more particularly, for linking in direct communication a restaurant and a potential customer for the restaurant.

### BACKGROUND

Currently, there are many different ways in which a vendor who provides goods or services attempts to attract a customer, and there are many ways in which a customer identifies those vendors that seem appealing or suiting to their needs. For example, a diner may simply wander an area that has a number of restaurants and select one that appears to offer the atmosphere and fare that the diner desires. To attract the diners as customers restaurants may display their menus out front and have windows allowing the diners to see into the restaurant. Diners may also rely on word of mouth, and a recent practice has been for restaurants to send people out to other bars or restaurants to talk up their establishment in an attempt to create a fad appeal or buzz.

Typically, people tend to resist simply setting out on a hunt for a restaurant without some basis for selecting the desired area. Often, people would rather look in a directory, such as a phone book for a restaurant serving, e.g., Chinese food or steak.

With the increased development and utility of the internet as a source of information gathering, people have come to rely, at least in part, on surfing the web as a means for identifying a restaurant. One of the difficulties, however, is locating a reliable directory. The internet is seen as a source for collecting information that allows a consumer to make fully informed choices. As such, people would rather go to a site that lists all the products or service providers available, and then consider the relative merits of each for themselves. Finding such a directory can be difficult for identifying restaurants, though not impossible.

Many such directories are operated by a network which has a broader goal of identification of entertainment choices, including movies, theater, bars, bowling alleys, art gallery and museum events, charity events, or summer festivals. For instance, the website of a daily newspaper, The Chicago Tribune, includes a site called Metromix which includes concerts, bars and restaurants, spas and gyms, and events, among other features. The site is principally driven by advertising revenues such that the listings are based on paying for the listing. The listings will typically include a telephone number if one would like information or, more specifically, would like to make a reservation. Some listings will include a link to a separately hosted website specific to a restaurant or the like, which typically will have a phone number for making a reservation.

Some restaurants have separately hosted websites. These may rely simply on a broad keyword search or on a listing such as the yellow pages feature of Yahoo!™, found on the internet at yahoo.com. Again, these restaurants typically give a phone number for making a reservation. Other times, these restaurants may have their own online reservation system.

Online reservation systems tend to be unreliable for a consumer or diner. For instance, if a diner requests a table for four, to be seated at 6:30 p.m. on a Thursday night, that information can be input to the restaurant's online system. However, if the restaurant personnel has fielded one or more telephone calls, or otherwise accepted reservations, without the online system's database being up-to-the-minute accurate, there will be a problem with attempting to honor the reservation. Maintaining the database with such accuracy is labor-intensive. To compound this fact, the diner who has received a confirmation of the reservation may not be reachable when the restaurant realizes the overbooking. At times, diners will presents themselves and their party to the restaurant at the appointed time only to discover their reservation will not be honored, or that they will have to wait an extended period of time. Other dining options may not be available nearby, or the extended wait to be seated may complicate further evening plans, such as theater tickets.

There are many other venues or arenas that potentially suffer the same difficulties. For instance, finer salons and spas typically require appointments. Golf courses, including public and municipal golf courses, require tee-times. Auto service shops, such as oil change companies and stereo installation services, often schedule appointments and service times.

It is clear that use of the internet benefits consumers and businesses alike. By presenting textual data, the likelihood of communication error is greatly reduced so that accuracy in what is sought is increased. The utility of the internet for easily presenting to potential customers business particulars, such as pricing, menus, or interior views of the establishment, is unparalleled. However, there is still a need for an improved system and method for vendors and customers, such as restaurants and diners, to make arrangements such as dining reservations.

### SUMMARY

In accordance with an aspect, a system for facilitating a relationship between a vendor and a potential customer for the vendor is disclosed, the system being located remotely from the vendor and the customer. The system includes at least one customer communications connection permitting the customer to connect to the system, to retrieve data from the system, and to input data to the system, an information retrieval function for collecting information in response to request by the customer, an information delivery function for sending the collected information to the customer, an information record function for storing information input by the customer, at least one vendor communications connection for connecting to the vendor, and for sending information to the vendor, and a connection function between the customer communications connection and the vendor communications connection allowing the customer to communicate with the vendor.

The customer communications connection of the system may include an internet capability permitting the customer to access the system, retrieve data from the system, and input data to the system via the internet. The customer communications connection may include a telephonic connection allowing the system to connect with the customer via telephone.

The system may include a database of information, and the information retrieval function collects information from the database for sending to the customer. The information retrieval function may collect information from an internet site based on the database information.

The vendor communications connection preferably includes a telephonic connection for sending information to the vendor, and the connection function allows the customer to speak with the vendor via the telephonic connection. The customer communications connection and the vendor communications connection preferably include respective telephonic connections, the data input by the customer includes a time to be contacted, and the connection function includes a call function for calling, via the respective telephonic connections, the customer and vendor at the time to be contacted.

The system also may include a message play function including an announcement function for addressing the customer and the vendor when each is respectively contacted via telephonic connections. The message play function may include an advertisement function for playing advertisements to at least the customer while contacting the vendor via the vendor telephonic connection.

In another aspect of the invention, a method is provided facilitating a relationship between a vendor and a potential customer. The method may include providing a remotely located system, permitting the customer to access information via the remote system, permitting the customer to input data to the remote system, storing the customer input data in the remote system, connecting with the vendor, and connecting the customer with the vendor.

The method may include providing at least a portion of the customer input data to the vendor. The customer input data may includes a request for a reservation, and/or a non-reservation request.

The method may further include a step of retrieving information in response to the customer input data, and a step of sending a portion of the retrieved information to the customer. The retrieving of information may include accessing information stored in the remote system, and accessing information from the internet.

The method may include connecting with the vendor by making a telephonic connection with the vendor to permit voice communications therewith. The method may further include connecting the customer with the vendor by making telephonic connections with each of the customer and vendor to permit voice communications therebetween. The method may include playing an advertisement via at least one telephonic connection, such as during the making of another telephonic connection.

In a further aspect, a method for facilitating arrangement of a reservation between a diner and a restaurant is disclosed. The method may include providing a remotely located system, permitting the customer to access information regarding at least one restaurant via the remote system, sending information regarding at least one restaurant to the customer from the remote system, receiving data input by the customer to input data into the remote system, connecting the remote system with the restaurant, and providing at least one telephonic connection for the customer and the restaurant,

The method may include storing at least a portion of the input data from the customer, and may include sending at least a portion of the input data from the customer to the restaurant. This portion of the input data may be sent to the restaurant via a telephonic communication. The customer input data may include a request for a reservation, and/or a non-reservation request.

The method may include retrieving information in response to the customer input data, and a step of sending a portion of the retrieved information to the customer. Retrieving the information may include accessing information stored in the remote system, and may include accessing information from the internet.

Providing a telephonic connection includes making a telephonic connection to permit voice communication. This may include making telephonic connections with each of the diner and the restaurant to permit voice communications therebetween. Once the telephonic connection is made between the system and either or both of the diner and restaurant, the method may include playing audio advertisements or other announcements.

### BRIEF DESCRIPTION OF THE DRAWINGS

FIG. 1 is a functional block diagrammatic representation of a system for linking a customer with a vendor of goods and/or services including a customer-use system, a vendor-use system, and a remote-use system;

FIG. 2 is a representation similar to FIG. 1 of a system for linking a diner with a restaurant including a diner-use system, a restaurant-use system, and a remote-use system;

FIG. 3 is a functional block diagrammatic representation of the remote-use system of FIG. 2 showing the components thereof;

FIG. 4 is a flowchart representing methods of operating the linking systems of FIGS. 1 and 2; and

FIG. 5 is a flowchart representing additional methods of operating the linking system of FIGS. 1 and 2.

### DETAILED DESCRIPTION

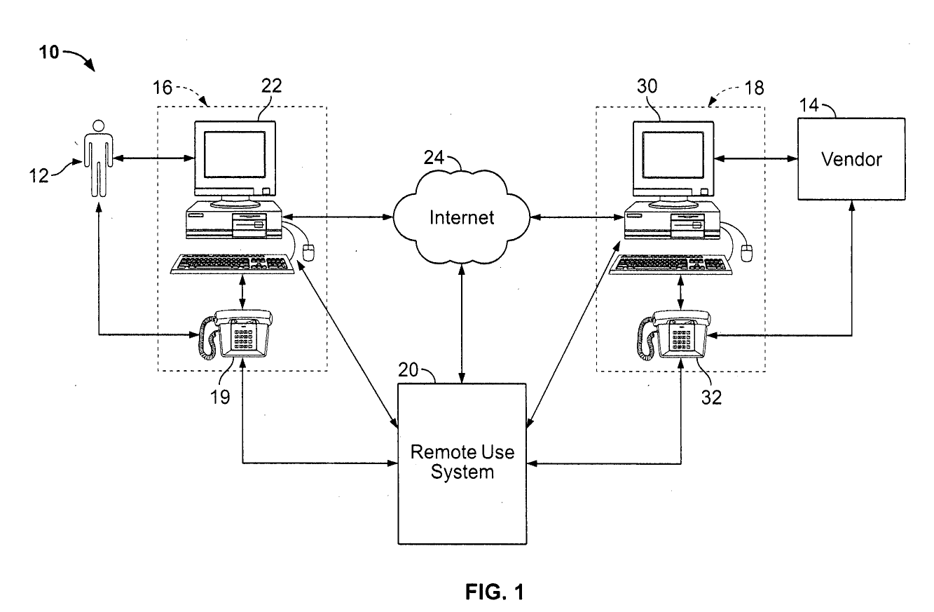

Referring initially to FIG. 1, a system 10 for linking a customer 12 and a vendor 14 of goods and/or services is depicted. The system 10 includes a customer-use system 16 with which the customer 12 inputs and receives information, and a vendor-use system 18 with which the vendor 14 receives and returns information. The system 10 further includes a remote-use system 20 with which the customer 12 initially communicates, and which provides one or more communications connections with the customer 12 and the vendor 14.

The customer 12 utilizes the customer-use system 16 to establish a communications connection with the remote-use system 20. The customer 12 requests information from the remote-use system 20, which replies with information tailored to the specific request of the customer 12. After one or more exchanges of information between the customer 12, via the customer-use system 16, and the remote-use system 20, the remote-use system 20 then establishes a communications connection between itself and the vendor 14 via the vendor-use system 18. The remote-use system 20 may utilize one or more communications connections both with the customer 12 and with the vendor 14.

In a preferred form, the customer-use system 16 includes a personal computer 22 that establishes a communications connection with the remote-use system 20 via the internet 24. The customer 12 utilizes the computer 22 to request information regarding one or more vendors 14 from the remote-use system 20, i.e., from a web site associated with the remote-use system 20. The remote-use system 20 either stores the information regarding the vendors 14 locally, or retrieves the information from the internet where various vendors 14 have separately hosted websites, for instance, or directly from the vendor-use system 18. The remote-use system 20 then delivers the information to the personal computer 22 for display to the customer 12. The customer 12 may make subsequent requests for information, and the remote-use system 20 will continue to deliver whatever is requested.

At some point, the customer 12 may make a selection of a particular vendor 14. To do so, the customer 14 provides an input indication to the personal computer 22 that is delivered to the remote-use system 20. The customer 12 may make the indication by directly communicating selection of a particular vendor 14, and then be asked to input data specific to information for transmittal of that information to the vendor 14, or the customer may simply input specific information fields, such as a date on which services are to be received, in order to communicate a selection of a vendor 14. In any event, the personal computer 22 and the remote-use system 20 send and receive information that prompt the customer 12 to input specified information necessary to the vendor 14.

Once the information is collected, the remote-use system 20 attempts to deliver the information to the vendor 14. The vendor-use system 18 may include a computer 30 system for providing the information originally requested by the customer 12, such as a locally-hosted website, and for receiving the information provided by the customer 12 via the remote-use system 20. The vendor-use system 18 may also or alternatively include a telephonic terminal 32 for receiving the information. The remote-use system 20 will also attempt to establish a connection between a telephone 19 of the customer 12 and telephone 32 of the vendor 14.

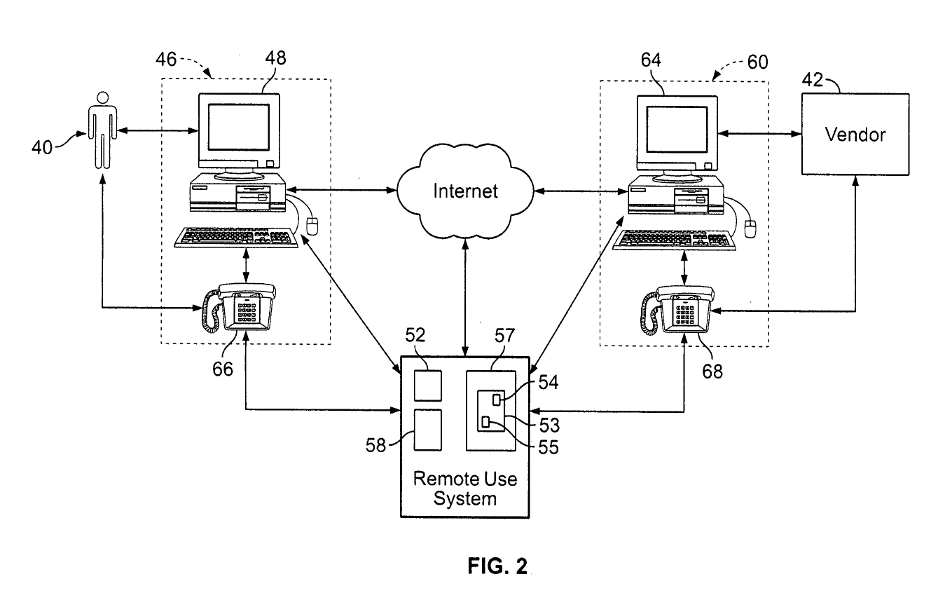

In one embodiment of a method of the invention depicted in FIG. 2, the customer 12 is a diner 40 seeking to identify restaurants that will accommodate the needs of the diner 40, and the vendor 14 is a restaurant 42 selected from among a group of restaurants. In a specific use of the system 10, the diner 40 is seeking to identify a particular restaurant and make a reservation for that restaurant.

The diner 40 uses a diner-use system 46 including a personal computer 48 to communicate with a remote-use system 50 via the internet. The diner 40 inputs various information to create search parameters. These parameters may include a particular area or location, based on city, zip code, or proximity to a street address; may include type of fare, such as Chinese, vegetarian, sushi, for instance; may include acceptance of certain pay forms, such as particular credit card companies; or a number of other criteria. The remote-use system 50 may include a database 52 including information relevant to the search parameters for a number of restaurants, or may access these from other sources, such as a computer 64 of a restaurant-use system 60, via the internet. The database 52 may also include record files for each restaurant, including telephone numbers, menus, pricing, and biographical information such as a marketing description of the restaurant, its clientele, its personnel such as owner or executive chef, and its atmosphere including photo images of the interior and exterior. The diner 40 then may make a selection of the restaurant 42, as described above.

In response to the selection, the remote-use system 50 requests information from the diner 40 in a textual manner, or displays drop-down menus or check boxes on the computer 48 of the diner 40, allowing accurate input of the information. For instance, a date for the reservation may be made by clicking on a calendar displayed on the computer 48, the time may be selected by clicking on a clock or drop down menu that has available times in predetermined increments, the number in the dining party may be input by a second drop down menu, and check boxes may be provided for such things as smoking/non-smoking seating, peanut allergy, or other pre-determined common criteria. Lastly, the remote-use system 50 queries, or accepts input, regarding when the diner 40 would like to be contacted for confirmation/arrangement of the reservation. The time at which the diner 40 would like to be contacted may be immediately or in a matter of minutes. Alternatively, the diner 40 may select a later time, such as may be desirable if the diner 40 would like to confer with another person on the selection or on their own schedule before making the reservation.

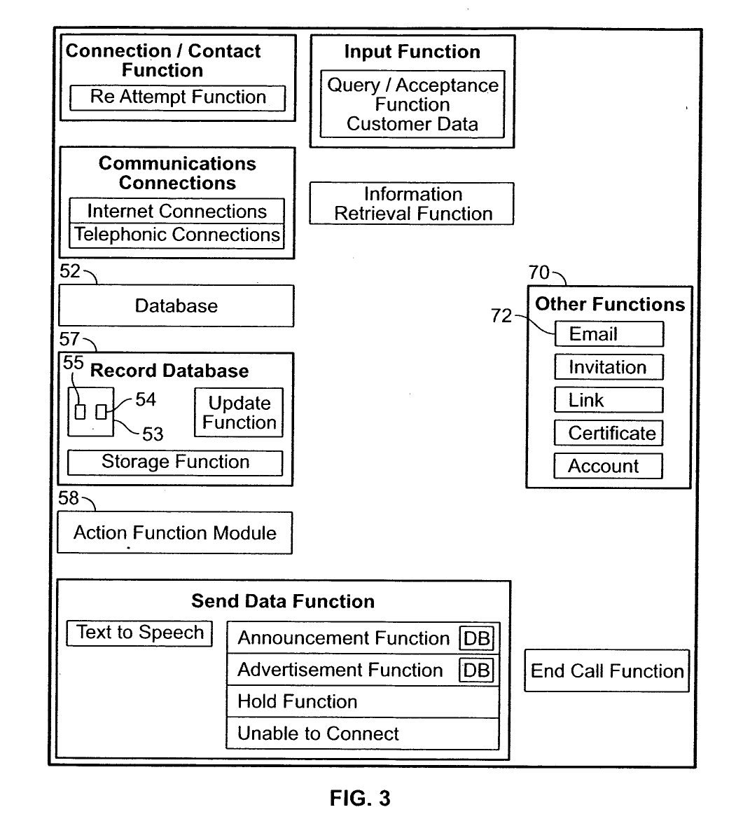

Referring also to FIG. 3, the remote-use system 50 saves the information as a record 53, typically a reservation record 54, in a database 57. The records 53 are mapped in the database 57 according to zip code. The remote-use system 50 includes an action module 58 which surveys the database 57 for new records 53.

At the diner-input time to be contacted, the remote-use system 50 attempts to contact the diner 40. Preferably, this is done by the remote-use system 50 telephoning the diner 40. Once the diner 40 has been connected, the remote-use system 50 attempts to contact the restaurant 42, as preferably via telephone. Towards this end, it is preferred that the diner-use system 46 includes a telephone 66, and the restaurant-use system 60 includes a telephone 68.

In order to connect the diner 40 and the restaurant 42, two conditions must be met. Specifically, the diner 40 and the restaurant 42 must respond to the remote-use system 50 attempting to contact both. For both the diner 40 and the restaurant 42, once the connection has been established by the remote-use system 50 at the input contact time, the remote-use system 50 determines whether the diner 40 and restaurant 42 have answered so as to insure that a voice-mail box has not been reached. If a voice mail box is reached for the diner 40, the restaurant 42 is never contacted, and the record 53 in the database 57 is updated to indicate contact was unsuccessful. The remote-use system 50 may be programmed to re-attempt contacting the diner 40, such as in a short period of time and/or may attempt to leave a message with a voice mail box. If the diner 40 is reached, the remote-use system 50 then calls the restaurant 42. During this time, the remote-use system 50 first identifies itself as the telephone connection of the reservation system the diner 40 used on-line. Next, the remote-use system 50 may play advertisements, which may be based on the telephone area code at which the diner 40 is being called or may be based on location for the restaurant 42 at which they are attempting to make a reservation. By way of example, the advertisement may describe restaurants or other business located in the area of the diner 40, or may be a theater or parking garage near where the restaurant 42 is located. The advertisement may also include information regarding the company who is providing the services of the remote-use system 50, and/or general advertisement such as for national brands. Preferably, a number of advertisements are rotated or chosen at random to be played. Between a plurality of advertisements, a message indicating that the remote-use system 50 is still making the connection to the restaurant 42 may be played, such as a “continuing to hold” message.

If the restaurant 42 does not respond, or is answered by a voice mail box, the remote-use system 50 disconnects (hangs-up) from the restaurant, plays a recorded message to the diner 40 indicating the inability to connect the diner 40 with the restaurant 42, and disconnects from the diner 40.

Otherwise, upon connecting with the restaurant 42, the remote-use system 50 identifies itself to the restaurant 42. The restaurant 42 may or may not have received an email or other web-based communication presenting the record 53 information prior to the phone call. The remote-use system 50 then presents the record 53 information to the restaurant 42, and notifies the restaurant 42 that the diner 40 is being connected to the restaurant 42 to discuss, arrange, and confirm the reservation. At that time, the diner 40 and the restaurant 42 are connected so that the two parties may speak directly, though the communication is still routed through the remote-use system 50.

Preferably, the remote-use system 50 limits the conversation time to five minutes. At four minutes and forty-five seconds, the remote-use system 50 indicates that the call will be ended in fifteen seconds. Within that time frame, it is believed that the diner 40 and restaurant 42 should have suitably communicated the necessary information, including an exchange of telephone numbers should the parties need to communicate further.

Preferably, the remote-use system 50 communicates the diner-input information audibly when the restaurant 42 answers the telephone call. Towards this end, the remote-use system 50 uses text-to-speech software, for instance, so that the person's name is announced, the requested reservation time and date, and the number in the dining party. Additionally, the remote-use system may communicate any other special requests, such as non-smoking.

As another feature of the system and method, the remote-use system 50 may create records 53 that are non-reservation or special records 55. The special record 55 may be communicated from the remote-use system 50 to the restaurant 42, either via telephone call or via the restaurant-use system computer 64. An example of a special record 55 would be where a diner 40 is simply looking for an opportunity to visit the restaurant sometime during a particular week.

In another facet of the system and method, the remote-use system 50 provides the diner 40 with additional functions 70. The diner 40 may log into the remote-use system 50 via the internet and, specifically, into an account that contains the record 53 of their reservation. The diner 40 then has access to the functions 70. One function 70 is an email function 72 so that, upon the diner 40 inputting one or more email addresses of guests, the remote-use system 50 distributes emails to the guests inviting them to join the diner 40 at the restaurant 42 at the particular reservation time. In the event the restaurant 42 was unable to host the specifically desired reservation time and date, the diner 40 may input the actual confirmed reservation time and date to override the default stored as the record 53. The record 53 is then modified to retain the originally requested reservation and the newly input reservation. The email function 72 also provides the guests with a web-type link 74, such as a hypertext transfer protocol link, to the internet website or the microsite of the restaurant 42 hosted by the remote-use system 50, directions to the restaurant 42, information about the area of the restaurant, such as convenient parking, or the restaurant 42 itself, all of which may be stored in the database 52, for instance, and a discount code to purchase dining certificates from the remote-use system 50 website, usable by the diner 40 or designate.

As can be seen, the remote-use system 50 is preferably automated requiring only the actions of the diner 40 and the restaurant 42. As described, the diner 40 logs into the remote-use system 50, such as through the internet, determines which restaurant 42 they would like to make a reservation with, and inputs information to the remote-use system 50. The remote-use system 50 communicates this information to the desired restaurant 42, and establishes a communications connection between the diner) 40 and the restaurant 42 so that the two parties can confirm the reservation. The remote-use system 50 also allows the diner 40 to send invitations to anticipated guests, and allows purchasing of dining certificates or coupons, delivered via email to the diner 40.

It should also be noted that the diner telephone 66 and the restaurant telephone 68 may be web-based telephony connections. In this event, the telephones 66,68 are connected via the internet by the remote-use system 50.

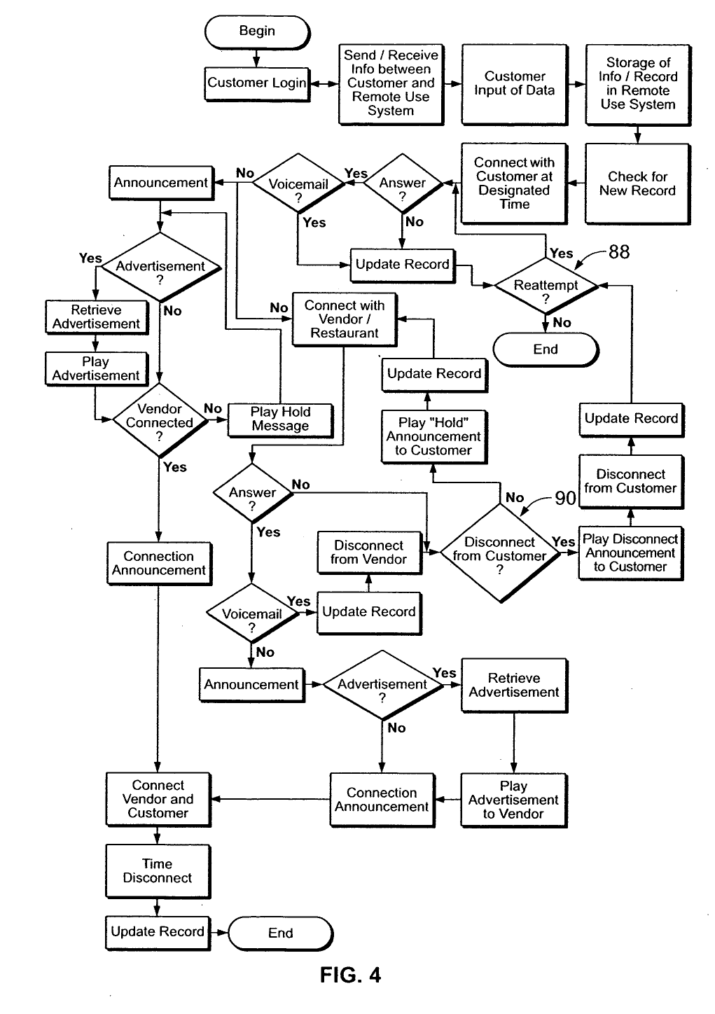

Referring now to FIG. 4, operation of the system and methods described herein can be seen. A customer 12, such as a diner 40, may login to the remote-use system 50 via their personal computer 48. Once a communications connection is established between the diner 40 and the remote-use system 50, information is sent and received between the customer 40 and the remote-use system 50. When a selection for a restaurant 42 has been made, the diner 40 inputs information, such as the time, date, and number of diners for a reservation, as well as a designated time to be contacted by the remote-use system 50. The remote-use system 50 stores this information as a new record 53, discussed-above, in the database 57.

The action function or module 58 surveys the database 57 for new records. Once the new record 53 is recognized, the remote-use system 50 waits until the designated time for contacting the diner 40. At that time, the remote-use system 50 establishes a communications connection with the diner 40, preferably via the telephone 66.

The remote-use system 50 makes a determination as to whether the call to the telephone 66 is successful by the telephone 66 answering. If the telephone 66 does not answer, the remote-use system 50 disconnects, updates the record 53 to include the fact that the diner 40 was called at the appointed time. The remote-use system 50 may then re-attempt to establish the connection by calling the telephone 66 again, or may be programmed to wait an additional time period before a re-attempt, represented by decision block 88.

When the telephone 66 answers, the remote-use system 50 first determines whether the telephone 66 has been answered by a voicemail system or box. If the answer is from a voicemail box, the remote-use system 50 disconnects from the telephone 66, updates the record 53 to include the facts that the diner 40 was called at the appointed time and a voicemail system answered. The remote-use system 50 may then call again, either immediately or after a pre-programmed time period, again represented by decision block 88.

Once a non-voicemail answer from the telephone 66 is recognized, the remote-use system 50 attempts to connect with the restaurant 42 through a communication connection of the remote-use system 50 used for contacting the restaurant 42. While connecting with the restaurant 42, the remote-use system 50 plays an announcement to the diner 40 identifying the source of the phone call. A decision is then made by the remote-use system 50 as to whether one or more advertisements is to be played to the diner 40. If an advertisement is to be played, the remote-use system retrieves the advertisement, and then plays it over the telephone 66 to the diner 40. Once the advertisement has concluded, the remote-use system 50 checks to see if a proper a connection has been made with the restaurant 42. If not, a “hold” message may be played, and another advertisement may be played.

As noted, the remote-use system 50 attempts to contact the restaurant 42 after the diner 40 has been called successfully. In the same manner as done when calling the diner 40, the remote-use system 50 checks for an answer, then checks for a non-voicemail answer. If an answer is not initially made, a “hold” message is played to the diner 40 indicating that the they are continuing to hold while the restaurant 42 is being contacted, and generally simultaneously the remote-use system 50 re-attempts to call the restaurant 42. If the answer from the restaurant 42 is a voicemail box, the remote-use system 50 disconnects from the voicemail and updates the record 53 to note the failure to properly connect with the restaurant 42. The remote-use system 50 then decides, at decision block 90, whether an immediate re-attempt should be made to the restaurant 42, whether it should wait. If it should wait, the remote-use system 50 plays a disconnect announcement message to the diner 42 announcing the inability to connect with the restaurant 42, and then disconnects from the diner 40. The record 53 is updated again, and the remote-use system 50 returns to decision block 88 to determine when and if to attempt to call both the diner and the restaurant again. If, at block 90, the remote-use system should immediately re-attempt to call the restaurant 42, the “hold” announcement is played, the record is updated, and the contact is again attempted.

Once both the restaurant 42 and the diner 40 are in communication with the remote-use system 50, one or more advertisements may be played to either or both of the parties, or connection announcements may simply be played both. The restaurant 42 and diner 40 are then connected. The connection is timed and, after a pre-determined period, the remote-use system 50 may cut the connection. It is believed that within a specific amount of time, for instance five minutes, the transaction should be complete. The record is then updated, and the process is ended.

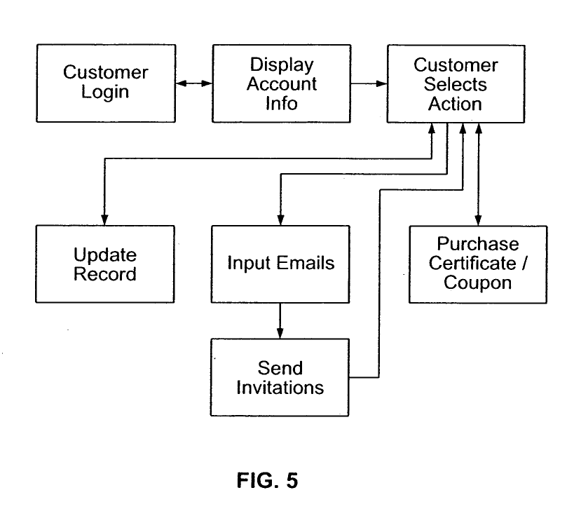

Referring now to FIG. 5, methods of operating the remote-use system 50 are represented. Beginning with a customer, such as a diner 40, logged into the remote-use system 50 and having a confirmed reservation, the diner 40 may use the remote-use system 50 to display the information contained in the record 53. In this manner, the diner 40 can recall the reservation. The diner 40 can then select from a number of activities or actions. For instance, the diner 40 may update the record 53 manually, such as may be necessary if the confirmed reservation differs from the originally selected or requested reservation. The diner 40 may input a guest list consisting of a plurality of email addresses and direct the remote-use system 50 to send invitations. It should be noted that the telephonic capabilities of the remote-use system 50 may be utilized to telephone a guest list of people via inputting a plurality of telephone numbers, and a combination of telephone numbers and email addresses may be provided for a guest list. Additionally, the diner 40 may use the account to purchase certificates or coupons specific to the restaurant 42 for which the reservation is made. These certificates can then be sent to the diner 40, or a guest/designate, via an email address.

In this manner, the diner 40 has access to the benefits and utility of the internet for searching for a restaurant, and can easily request to be called at a particular time for confirming the reservation. The remote-use system 50 stores the reservation information for ease of retaining the information and for forwarding the information on to other people.

While the invention has been described with respect to specific examples, including presently preferred modes of carrying out the invention, those skilled in the art will appreciate that there are numerous variations and permutations of the above described systems and techniques that fall within the spirit and scope of the invention as set forth in the appended claims.

What is claimed is:

1. A computer implemented system operating under control of a stored program, the system facilitating a relationship between a vendor and a potential customer for the vendor and being located remotely from the vendor and the customer, the program including:
at least one customer communications connection portion permitting the customer to connect to the system, to retrieve data from the system, and to input data to the system;
an information retrieval function portion for collecting information in response to request by the customer;
an information delivery function portion for sending the collected information to the customer;
an information record function portion for storing information input by the customer;
at least one vendor communications connection portion for connecting to the vendor, and for sending information to the vendor; and
a connection function portion between the customer communications connection and the vendor communications connection allowing the customer to communicate with the vendor.

2. The system of claim 1 wherein the customer communications connection portion includes an internet capability permitting the customer to access the system, retrieve data from the system, and input data to the system via the internet.

3. The system of claim 2 wherein the customer communications connection portion further includes a telephonic connection allowing the system to connect with the customer via telephone.

4. The system of claim 1 wherein the system further includes a database of information, and the information retrieval function portion collects information from the database for sending to the customer.

5. The system of claim 1 wherein the system further includes a database of information, and the information retrieval function portion collects information from an internet site based on the database of information.

6. The system of claim 1 wherein the vendor communications connection portion includes a telephonic connection for sending information to the vendor, and the connection function portion allows the customer to speak with the vendor via a telephonic connection.

7. The system of claim 1 wherein the customer communications connection portion and the vendor communications connection portion include respective telephonic connection portions, the data input by the customer includes a time to be contacted, and the connection function portion includes a call function portion for calling, via the respective telephonic connection portions, the customer and vendor at the time to be contacted.

8. The system of claim 7 including a message play function portion including an announcement function portion for addressing the customer and the vendor when each is respectively contacted via the telephonic connection portions.

9. The system of claim 8 wherein the message play function portion includes an advertisement function portion for playing advertisements to at least the customer while contacting the vendor via the vendor telephonic connection portion.

10. A method for facilitating a relationship between a vendor and a potential customer, the method including:
providing a remotely located system;
permitting the customer to access information via the remotely located system;
permitting the customer to input data to the remotely located system;
storing the customer input data in the remotely located system;
connecting the remotely located system with the vendor;
connecting the customer with the vendor.

11. The method of claim 10 further including a step of providing at least a portion of the customer input data to the vendor.

12. The method of claim 11 wherein the customer input data includes a request for a reservation.

13. The method of claim 11 wherein the customer input data includes a non-reservation request.

14. The method of claim 10 further including a step of retrieving information in response to the customer input data, and a step of sending at least a portion of the retrieved information to the customer.

15. The method of claim 14 wherein the step of retrieving information includes accessing information stored in the remotely located system.

16. The method of claim 14 wherein the step of retrieving information includes accessing information from the internet.

17. The method of claim 10 wherein the step of connecting with the vendor includes making a telephonic connection with the vendor to permit voice communications therewith.

18. The method of claim 10 wherein the step of connecting the customer with the vendor includes making telephonic connections with each of the customer and vendor to permit voice communications therebetween.

19. The method of claim 10 the step of connecting the customer with the vendor includes playing an advertisement via at least one telephonic connection.

20. A method for facilitating arrangement of a reservation between a diner and a restaurant, the method including:
providing a remotely located system;
permitting the customer to access information regarding at least one restaurant via the remotely located system;
sending information regarding at least one restaurant to the customer from the remotely located system;
receiving data input by the customer to input data into the remotely located system;
connecting the remotely located system with the restaurant;
providing at least one telephonic connection for communication with the customer and the restaurant.

21. The method of claim 20 further including the step of storing at least a portion of the input data from the customer.

22. The method of claim 21 further including sending at least a portion of the input data from the customer to the restaurant.

23. The method of claim 20 wherein the customer input data includes a request for a reservation.

24. The method of claim 20 wherein the customer input data includes a non-reservation request.

25. The method of claim 20 further including a step of retrieving information in response to the customer input data, and a step of sending a portion of the retrieved information to the customer.

26. The method of claim 25 wherein the step of retrieving information includes accessing information stored in the remotely located system.

27. The method of claim 25 wherein the step of retrieving information includes accessing information from the internet.

28. The method of claim 20 wherein the step of providing a telephonic connection includes making a telephonic connection to permit voice communication.

29. The method of claim 20 wherein the step of providing a telephonic connecting includes making telephonic connections with each of the diner and the restaurant to permit voice communications therebetween.

30. The method of claim 20 wherein the step of providing a telephonic connection includes playing audio advertisement.
